(19) United States
(12) Patent Application Publication
(10) Pub. No.: US 2020/0039239 A1
(43) Pub. Date: Feb. 6, 2020

(54) FOIL TRANSFER DEVICE

(71) Applicant: Roland DG Corporation, Hamamatsu-shi (JP)

(72) Inventor: Fumihiro TAKAHASHI, Hamamatsu-shi (JP)

(21) Appl. No.: 16/525,640

(22) Filed: Jul. 30, 2019

(30) Foreign Application Priority Data
Aug. 6, 2018 (JP) 2018-147435

(51) Int. Cl. B41J 2/475; B41J 13/10; B41M 5/26; B44C 1/17; B44C 1/24

(52) U.S. Cl. CPC B41J 2/475; B41J 13/10; B44C 1/24; B44C 1/17; B41M 5/26

(57) ABSTRACT

A foil transfer device divides a track, calculated for a foil transfer tool based on an image, into a transfer track on which the foil transfer tool foil-transfers the image and a non-transfer track on which the foil transfer tool does not foil-transfer the image. While the foil transfer tool is moved on the transfer track, the foil transfer device keeps the foil transfer tool in a first state where the foil transfer tool is in direct or indirect contact with, and presses, the heat transfer foil at a pressure larger than, or equal to, a first pressure. While the foil transfer tool is moved on the non-transfer track, the foil transfer device keeps the foil transfer tool in a second state where the foil transfer tool is in direct or indirect contact with, and presses, the heat transfer foil at a pressure smaller than, or equal to, the first pressure.

### CROSS REFERENCE TO RELATED APPLICATION

This application claims the benefit of priority to Japanese Patent Application No. 2018-147435 filed on Aug. 6, 2018. The entire contents of this application are hereby incorporated herein by reference.

### BACKGROUND OF THE INVENTION

### 1. Field of the Invention

The present invention relates to a foil transfer device.

### 2. Description of the Related Art

Conventionally, a foil transfer device (also referred to as a “foil stamping device”) using a heat transfer foil is known. Foil transfer is performed as follows by a foil transfer device. A heat transfer foil is stacked on a transfer target, and is heated while being pressed from above by a foil transfer tool. As a result, an image is transferred onto a surface of the transfer target.

For example, Japanese Laid-Open Patent Publication No. 2013-220536 discloses a foil stamping device including, as a foil transfer tool, a pen that may be heated to a predetermined range of temperature. For example, Japanese Laid-Open Patent Publication No. 2016-215599 discloses a foil stamping device including, as a foil transfer tool, an optical pen that radiates laser light.

An image to be transferred onto a transfer target may include a plurality of image portions separate from each other. In order to perform foil transfer of such an image, the foil transfer tool moves between the image portions separate from each other without performing foil transfer. The foil transfer tool moves like this without performing foil transfer while, for example, being out of contact with the heat transfer foil. In this case, the foil transfer tool is moved to be spaced away from the heat transfer foil, and then is moved to press the heat transfer foil again. The time required to allow the foil transfer tool to move up or move down the heat transfer foil may decrease the productivity of the foil transfer.

### SUMMARY OF THE INVENTION

Preferred embodiments of the present invention provide foil transfer devices that each shorten a time required to move a foil transfer tool while foil transfer is not performed and thus to improve the productivity of the foil transfer.

A foil transfer device disclosed herein includes a holding table, a foil transfer tool, a horizontal direction conveyor, a vertical direction conveyor, and a controller. The holding table holds a transfer target with a heat transfer foil placed thereon. The foil transfer tool is located above the holding table. The horizontal direction conveyor moves the foil transfer tool and the holding table in a horizontal direction with respect to each other. The vertical direction conveyor moves the foil transfer tool and the holding table in a vertical direction with respect to each other. The controller includes a storage, a track calculator, a horizontal movement controller, and a vertical movement controller. The storage stores data on an image to be foil-transferred onto the transfer target. The track calculator calculates, based on the data stored on the storage, a track on which the foil transfer tool and the holding table are moved in the horizontal direction with respect to each other by the horizontal direction conveyor, and divides the track into a transfer track on which the foil transfer tool transfers the image and a non-transfer track on which the foil transfer tool does not transfer the image. The horizontal movement controller controls the horizontal direction conveyor to move the foil transfer tool and the holding table with respect to each other in the horizontal direction along the track calculated by the track calculator. The vertical movement controller controls the vertical direction conveyor to move the foil transfer tool and the holding table with respect to each other in the vertical direction. While the foil transfer tool and the holding table are moved on the transfer track with respect to each other, the vertical movement controller keeps the foil transfer tool in a first state where the foil transfer tool is in direct or indirect contact with the heat transfer foil and presses the heat transfer foil at a pressure larger than, or equal to, a first pressure. While the foil transfer tool and the holding table are moved on the non-transfer track with respect to each other, the vertical movement controller keeps the foil transfer tool in a second state where the foil transfer tool is in direct or indirect contact with the heat transfer foil and presses the heat transfer foil at a pressure smaller than, or equal to, the first pressure.

According to the above-described foil transfer device, in the second state, the foil transfer tool does not strongly press the heat transfer foil and thus the foil transfer is not performed. In addition, in the second state, the foil transfer tool is in contact with the heat transfer foil. Therefore, the distance by which the foil transfer tool is moved up to be moved from the transfer track to the non-transfer track, and the distance by which the foil transfer tool is moved down to be moved from the non-transfer track to the transfer track, are short. This shortens the time required to move the foil transfer tool from the transfer track to the non-transfer track, and the time required to move the foil transfer tool from the non-transfer track to the transfer track. As a result, the productivity of the foil transfer is improved.

Another foil transfer device disclosed herein includes a holding table, a foil transfer tool, a horizontal direction conveyor, a vertical direction conveyor, and a controller. The holding table holds a transfer target having a heat transfer foil placed thereon. The foil transfer tool is located above the holding table. The horizontal direction conveyor moves the foil transfer tool and the holding table in a horizontal direction with respect to each other. The vertical direction conveyor moves the foil transfer tool and the holding table in a vertical direction with respect to each other. The controller includes a storage, a track calculator, a horizontal movement controller, a vertical movement controller, a mode selector, and an energy controller. The storage stores data on an image to be foil-transferred onto the transfer target. The track calculator calculates, based on the data stored on the storage, a track on which the foil transfer tool and the holding table are moved in the horizontal direction with respect to each other by the horizontal direction conveyor, and divides the track into a transfer track on which the foil transfer tool transfers the image and a non-transfer track on which the foil transfer tool does not transfer the image. The horizontal movement controller controls the horizontal direction conveyor to move the foil transfer tool and the holding table with respect to each other in the horizontal direction along the track calculated by the track calculator. The vertical movement controller controls the vertical direction conveyor to move the foil transfer tool and the holding table with respect to each other in the vertical direction. The mode selector is capable of selecting a transfer mode from at least a first mode and a second mode. The energy controller controls a level of energy of the foil transfer tool. The energy controller causes the foil transfer tool to output a level of energy that realizes the foil transfer while the foil transfer tool and the holding table are moved with respect to each other on the transfer track, and does not cause the foil transfer tool to output the level of energy that realizes the foil transfer while the foil transfer tool and the holding table are moved with respect to each other on the non-transfer track. In the case where the first mode is selected by the mode selector, while the foil transfer tool and the holding table are moved on the non-transfer track with respect to each other, the vertical movement controller controls the vertical direction conveyor such that the foil transfer tool presses the heat transfer foil at a pressure smaller than a pressure while the foil transfer tool and the holding table are moved on the transfer track with respect to each other. In the case where the second mode is selected by the mode selector, the vertical movement controller controls the vertical direction conveyor such that the foil transfer tool presses the heat transfer foil at an equal pressure while the foil transfer tool and the holding table are moved on the non-transfer track with respect to each other and while the foil transfer tool and the holding table are moved on the transfer track with respect to each other.

According to the above-described another foil transfer device, while being moved on the non-transfer track with respect to the holding table, the foil transfer tool does not output the level of energy that realizes the foil transfer. Therefore, in the second mode as well as in the first mode, the foil transfer is performed only while the foil transfer tool is moving on the transfer track, and is not performed while the foil transfer tool is moving on the non-transfer track. According to the foil transfer in the second mode, in the case where, for example, the transfer target is made of a soft material, the trace of the foil transfer tool pressing the heat transfer foil may be left in the transfer target. However, according to the second mode, it is not needed to switch the pressing state of the foil transfer tool while the foil transfer tool is moved between the transfer track and the non-transfer track. As a result, the time required for the foil transfer is shortened. In the case where the productivity is prioritized than not leaving the trace in the transfer target, the second mode is preferably usable. As can be seen, the foil transfer device uses the first mode and the second mode in different cases or for different purposes and thus provides a good balance between the foil transfer quality and the productivity.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically showing a foil transfer device according to a preferred embodiment of the present invention.

FIG. 2 is a partially cut perspective view schematically showing the foil transfer device.

FIG. 3 is a left side view schematically showing a vertical direction conveyor, a horizontal direction conveyor and a holding table.

FIG. 4 is a plan view schematically showing the holding table at a maintenance position.

FIG. 5 is a plan view schematically showing the holding table at a securing position.

FIG. 6 is a vertical cross-sectional view schematically showing a structure of a head and the vicinity thereof.

FIG. 7 is a block diagram of the foil transfer device.

FIG. 8 is a schematic view showing an example of image to be foil-transferred.

FIG. 9 is a timing diagram showing the pressure applied to the foil transfer tool and the state of a light source when the image shown in FIG. 8 is foil-transferred in the case where a first mode is selected.

FIG. 10 is a timing diagram showing the pressure applied to the foil transfer tool and the state of the light source when the image shown in FIG. 8 is foil-transferred in the case where a second mode is selected.

### DETAILED DESCRIPTION OF THE PREFERRED EMBODIMENTS

Hereinafter, preferred embodiments of foil transfer devices according to preferred embodiments of the present invention will be described with reference to the drawings. The preferred embodiments described herein are not intended to specifically limit the present invention, needless to say. Components and portions that have the same functions will bear the same reference signs, and overlapping descriptions will be omitted or simplified.

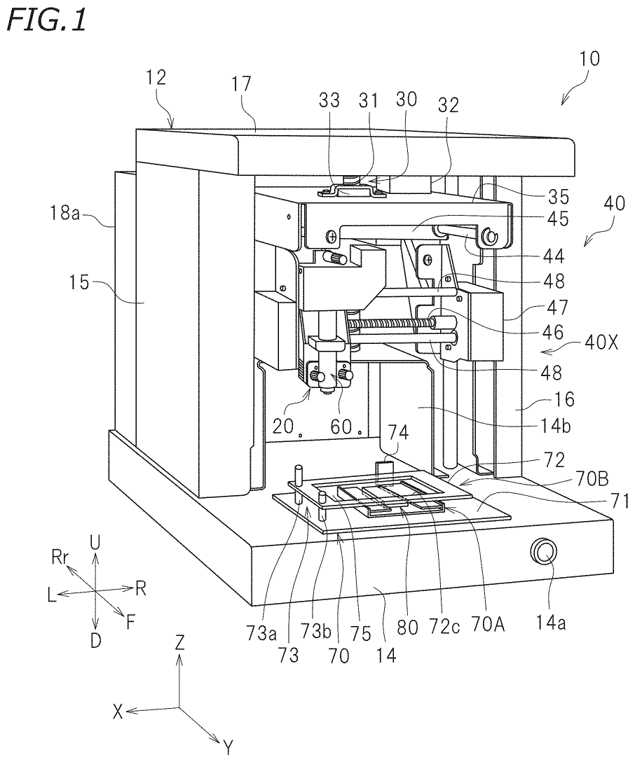

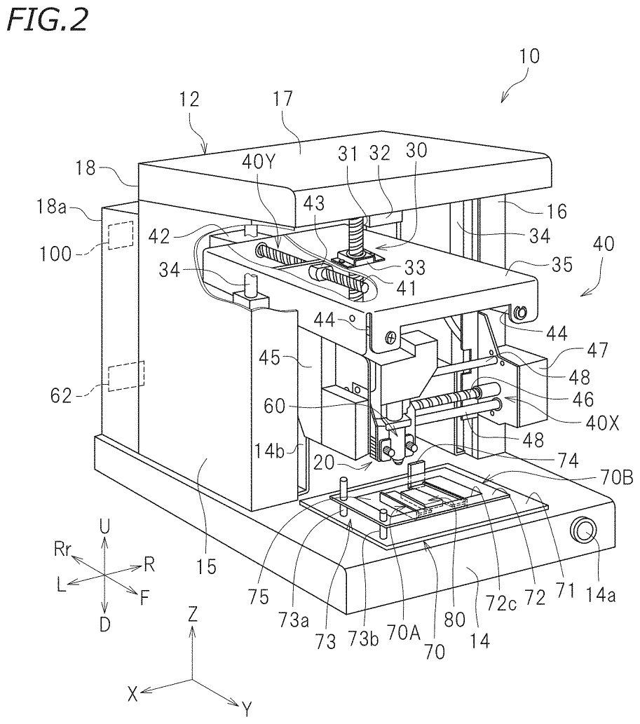

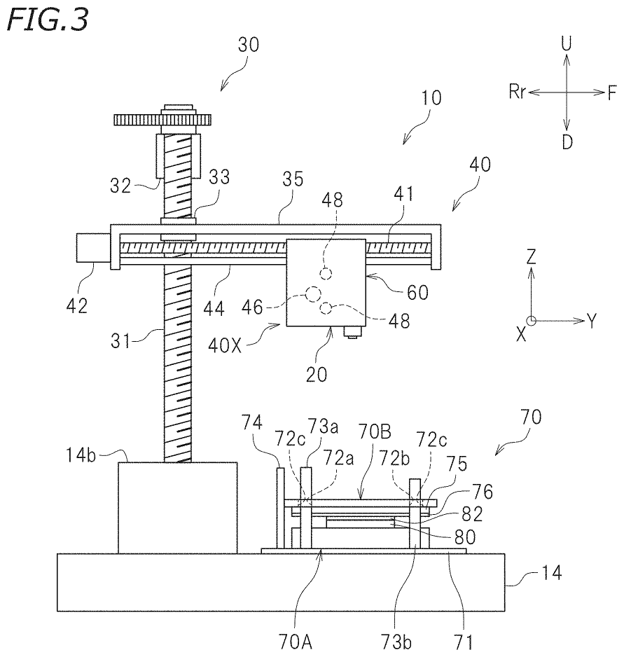

FIG. 1 is a perspective view of a foil transfer device 10. FIG. 2 is a partially cut perspective view schematically showing the foil transfer device 10. FIG. 3 is a left side view schematically showing a vertical direction conveyor 30, a horizontal direction conveyor 40, and a holding table 70. In the following description, the terms “left”, “right”, “up” and “down” respectively refer to left, right, up and down as seen from a user looking at a power button 14a on a front surface of the foil transfer device 10. A direction in which the user approaches the foil transfer device 10 is referred to as “rearward”, and a direction in which the user is spaced away from the heat foil device 10 is referred to as “forward”. In the drawings, letters F, Rr, L, R, U and D respectively represent front, rear, left, right, up and down. Where an X axis, a Y axis and a Z axis cross each other perpendicularly, the foil transfer device 10 in this preferred embodiment is placed on a plane defined by the X axis and the Y axis. In this preferred embodiment, the X axis extends in a left-right direction. The Y axis extends in a front-rear direction. The Z axis extends in an up-down direction. The above-described directions are merely defined for the sake of convenience, and do not limit the manner of installation of the foil transfer device 10 in any way.

As shown in FIG. 1, the foil transfer device 10 has a box shape. The foil transfer device 10 includes a housing 12 having a front opening, a head unit 20 located in the housing 12, the vertical direction conveyor 30, the horizontal direction conveyor 40, a foil transfer tool 60, and the holding table 70. The housing 12 includes a bottom wall 14, a left side wall 15, a right side wall 16, a top wall 17 and a rear wall 18 (see FIG. 2). The housing 12 is made of, for example, a steel plate.

As shown in FIG. 2, the left side wall 15 extends upward from a left end of the bottom wall 14. The left side wall 15 is perpendicular or substantially perpendicular to the bottom wall 14. The right side wall 16 extends upward from a right end of the bottom wall 14. The right side wall 16 is perpendicular or substantially perpendicular to the bottom wall 14. The rear wall 18 extends upward from a rear end of the bottom wall 14. The rear wall 18 is connected with a rear end of the left side wall 15 and a rear end of the right side wall 16. A box-shaped case 18a is provided on the rear wall 18. The case 18a accommodates a controller 100 described below. The top wall 17 is connected with a top end of the left side wall 15, a top end of the right side wall 16 and a top end of the rear wall 18. A portion of the vertical direction conveyor 30 is provided in the top wall 17. A region enclosed by the bottom wall 14, the left side wall 15, the right side wall 16, the top wall 17 and the rear wall 18 is an inner space of the housing 12.

As shown in FIG. 1, the holding table 70 is provided on the bottom wall 14. In the state where the foil transfer device 10 is placed on a horizontal plane defined by the X axis and the Y axis, the holding table 70 is located horizontally and extends in a horizontal direction. The holding table 70 holds a heat transfer foil 82 (see FIG. 3), films required for heat transfer and a transfer target 80. In this preferred embodiment, the holding table 70 holds the transfer target 80 while having the heat transfer foil 82 and a light absorbing film 76 placed thereon. The holding table 70 includes a securing tool 70A and a film holding tool 70B.

The securing tool 70A holds the transfer target 80. The securing tool 70A is, for example, a vise. The securing tool 70A is detachably attached to the holding table 70. Alternatively, the securing tool 70A may be non-detachably attached to the holding table 70.

There is no specific limitation on the material or the shape of the transfer target 80. The transfer target 80 may be formed of, for example, a resin such as acrylic resin, polyvinyl chloride (PVC), polyethyleneterephthalate (PET), polycarbonate (PC) or the like; paper such as plain paper, drawing paper, Washi (traditional Japanese paper) or the like; rubber; a metal material such as gold, silver, copper, platinum, brass, aluminum, iron, titanium, stainless steel or the like; etc.

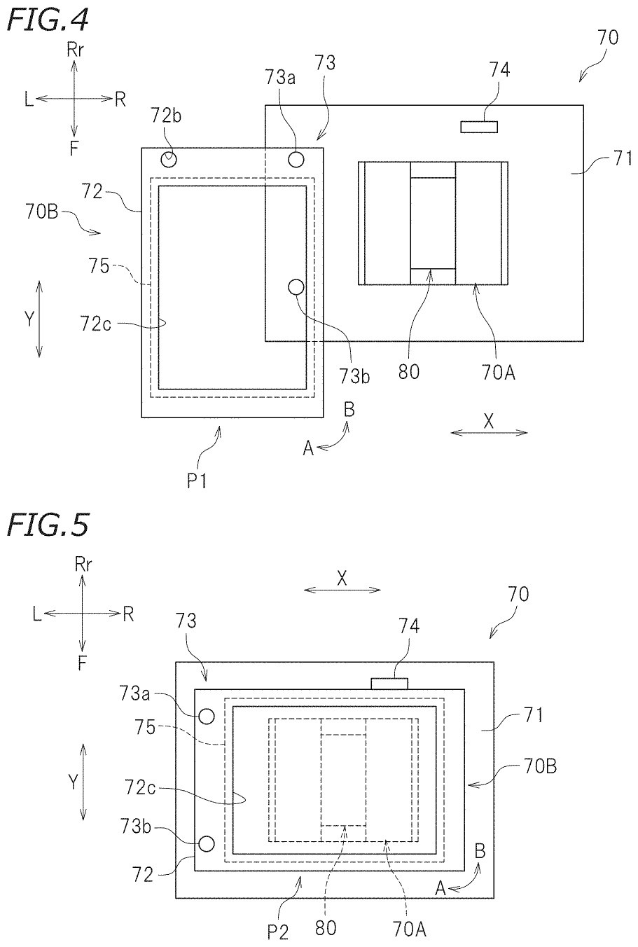

FIG. 4 and FIG. 5 are each a plan view schematically showing the holding table 70. As shown in FIG. 4 and FIG. 5, the film holding tool 70B includes a base 71, a holder 72, a support 73, a stopper 74, and a foil securing film 75. As described below in detail, the holder 72 is rotatable along the horizontal plane. FIG. 4 shows a state where the holder 72 is at a maintenance position P1, which is one of rotation positions thereof. FIG. 5 shows a state where the holder 72 is at a securing position P2, which is another one of the rotation positions thereof.

As shown in FIG. 1, the base 71 is provided on the bottom wall 14. The base 71 has a flat plate shape. The support 73 extends upward from the base 71. The support 73 includes a first slide bar 73a and a second slide bar 73b. The first slide bar 73a and the second slide bar 73b extend upward from the base 71. The first slide bar 73a and the second slide bar 73b extend upward from a left end of the base 71. The first slide bar 73a is located to the rear of the second slide bar 73b. The first slide bar 73a and the second slide bar 73b are located parallel or substantially parallel to each other. The first slide bar 73a is longer than the second slide bar 73b in the up-down direction.

The holder 72 holds the foil securing film 75 and the light absorbing film 76 (FIG. 3). As shown in FIG. 1, the holder 72 is held so as to movable in the up-down direction along the first slide bar 73a and the second slide bar 73b. The holder 72 is located above the base 71. As shown in FIG. 3, the holder 72 includes a first through-hole 72a, through which the first slide bar 73a is inserted, and also includes a second through-hole 72b, through which the second slide bar 73b is inserted. The holder 72 is movable upward to draw the second slide bar 73b from the second through-hole 72b. In this state, the holder 72 is supported only by the first slide bar 73a. As a result, as shown in FIG. 4, the holder 72 is rotatable in a direction of arrow A and a direction of arrow B as being centered around the first slide bar 73a.

The holder 72 may be located at the securing position P2 (see FIG. 5) and the maintenance position P1 (see FIG. 4) by rotating in the direction of arrow A and the direction of arrow B. The holder 72 is located at the securing position P2 in order to secure the heat transfer foil 82 to the transfer target 80 by the foil securing film 75. At the securing position P2, the holder 72 is above the securing tool 70A. When the holder 72 is at the securing position P2, the first slide bar 73a is inserted into the first through-hole 72a and the second slide bar 73b is inserted into the second through-hold 72b. The holder 72 may be moved in a vertical direction in this state. In this manner, the support 73 allows the holder 72 to move in the vertical direction above the transfer target 80.

The holder 72 is located at the maintenance position P1 in order to replace the foil securing film 75 held by the holder 72 with another foil securing film, in order to detach the securing tool 70A from the holding table 70, or in order to detach the transfer target 80 secured to the securing tool 70A from the securing tool 70A. When the holder 72 is at the maintenance position P1, the first slide bar 73a is inserted into the first through-hole 72a, whereas the second slide bar 73b is not inserted into the second through-hole 72b.

As shown in FIG. 5, the holder 72 includes an opening 72c running therethrough in the up-down direction. The opening 72c is rectangular or substantially rectangular. The opening 72c is larger than the securing tool 70A. More specifically, the opening 72c is longer than the securing tool 70A in the left-right direction, and the opening 72c is longer than the securing tool 70A in the front-rear direction. When the holder 72 is at the securing position P2, the securing tool 70A and the opening 72c overlap each other as seen in a plan view. More specifically, the securing tool 70A is located in the opening 72c as seen in a plan view.

The foil-securing film 75 is held by the holder 72 so as to overlap the opening 72c as seen in a plan view. The foil-securing film 75 is larger than the opening 72c, and is held by the holder 72 so as to overlap the entirety of the opening 72c as seen in a plan view. The foil-securing film 75 is held on a bottom surface of the holder 72. There is no specific limitation on the method for holding the foil securing film 75. For example, the foil securing film 75 is held on the bottom surface of the holder 72 with a two-sided tape. The light absorbing film 76 is secured to a bottom surface of the foil securing film 75. There is no specific limitation on the method for securing the light absorbing film 76 to the foil securing film 75. For example, the light absorbing film 76 is secured to the foil securing film 75 with a light-transmissive adhesive or a light-transmissive two-sided tape. The foil securing film 75 presses the heat transfer foil 82 from above to secure the heat transfer foil 82 on the transfer target 80. A large portion of the pressing force is provided by the weight of the holder 72.

The stopper 74 restricts the rotation of the holder 72. As shown in FIG. 1, the stopper 74 extends upward from the base 71. The stopper 74 is located to the rear of the first slide bar 73a. A top end of the stopper 74 is located above a top end of the second slide bar 73b. The top end of the stopper 74 is, for example, located above a top end of the first slide bar 73a. As shown in FIG. 5, when the holder 72 is at the securing position P2, the stopper 74 restricts the holder 72 from rotating in the direction of arrow B in FIG. 5. When the holder 72 is at the securing position P2, the stopper 74 is in contact with the holder 72.

A bonded body of the foil securing film 75 and the light absorbing film 76 presses the heat transfer foil 82 from above to secure the heat transfer foil 82 to the transfer target 80. Namely, the transfer target 80 and the films are stacked in the order of the transfer target 80, the heat transfer foil 82, the light absorbing film 76 and the foil securing film 75 from below to above. When, for example, the holder 72 is at the maintenance position P1, the heat transfer foil 82 is placed on the transfer target 80. Then, when the holder 72 is moved to the securing position P2, the heat transfer foil 82 is secured to the transfer target 80 by the bonded body of the foil securing film 75 and the light absorbing film 76.

The foil securing film 75 is light-transmissive. The foil securing film 75 is made of a material that is significantly lower in the light absorbance than the light absorbing film 76. The foil securing film 75 is, for example, transparent. In this preferred embodiment, the foil securing film 75 has a higher strength than that of the light absorbing film 76. The foil securing film 75 has a thickness of, for example, about 25 μm to about 100 μm. There is no specific limitation on the material of the foil securing film 75. The foil securing film 75 is made of, for example, a plastic material such as polyester or the like.

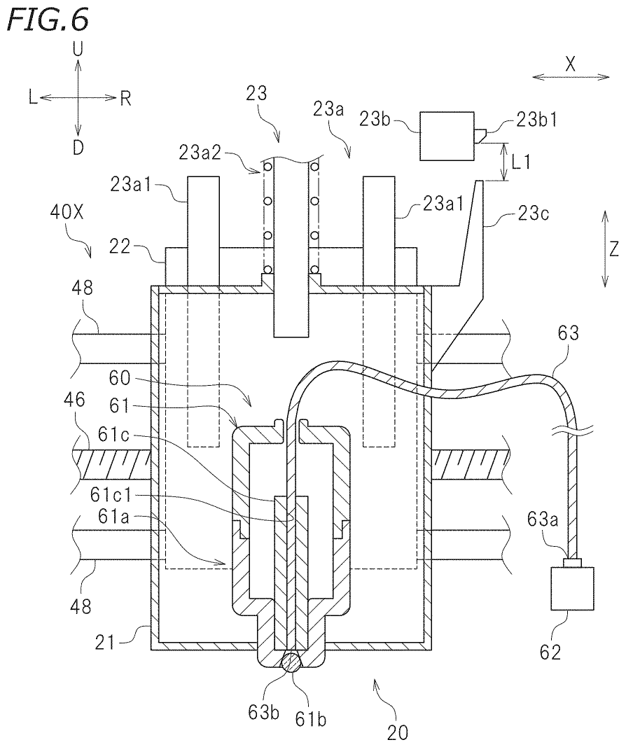

The light absorbing film 76 efficiently absorbs light of a predetermined wavelength range (laser light) emitted from a light source 62 (see FIG. 6) of the foil transfer tool 60 and converts the optical energy into thermal energy. The light absorbing film 76 is made of, for example, a resin such as polyimide or the like. The light absorbing film 76 is resistant against heat of a temperature of, for example, about 100° C. to about 200° C.

The heat transfer foil 82 is heated and pressed to transfer an image to a surface of the transfer target 80. In this preferred embodiment, the heat transfer foil 82 performs foil transfer by use of optical energy of light emitted by the light source 62 of the foil transfer tool 60. The heat transfer foil 82 may be any common transfer foil commercially available for foil transfer with no specific limitation. The heat transfer foil 82 generally includes a substrate, a decoration layer, and an adhesive layer stacked in this order. The decoration layer of the heat transfer foil 82 may be, for example, a metallic foil such as a gold foil, a silver foil or the like, a half metallic foil, a pigment foil, a multi-color printed foil, a hologram foil, an electrostatic discharge-preventive foil or the like. In this preferred embodiment, the light absorbing film 76 is separate from the heat transfer foil 82. Alternatively, the heat transfer foil 82 may include a light absorbing layer having a function equivalent to that of the light absorbing film 76. In such a case, the light absorbing film 76 does not need to be included. The light absorbing layer has a thickness of, for example, about 1 μm to about 15 μm.

In the inner space of the housing 12, the vertical direction conveyor 30 and the horizontal direction conveyor 40 are provided. The vertical direction conveyor 30 moves the foil transfer tool 60 and the holding table 70 in the vertical direction with respect to each other. The “vertical direction” is perpendicular or substantially perpendicular to the horizontal direction. In this preferred embodiment, the vertical direction conveyor 30 moves the head unit 20 and the foil transfer tool 60 provided in the head unit 20 in the vertical direction. It should be noted that the vertical direction conveyor 30 merely needs to move the foil transfer tool 60 and the holding table 70 in the vertical direction with respect to each other. There is no limitation on which one of the foil transfer tool 60 and the holding table 70 is to be moved. The horizontal direction conveyor 40 moves the foil transfer tool 60 and the holding table 70 in the horizontal direction with respect to each other. In this preferred embodiment, the horizontal direction conveyor 40 moves the head unit 20 and the foil transfer tool 60 in the horizontal direction with respect to each other. As shown in FIG. 2, the horizontal direction conveyor 40 includes a Y-axis direction conveyor 40Y moving the head unit 20 in a Y-axis direction and an X-axis direction conveyor 40X moving the head unit 20 in an X-axis direction. It should be noted that the horizontal direction conveyor 40 merely needs to move the foil transfer tool 60 and the holding table 70 in the horizontal direction with respect to each other. There is no limitation on which one of the foil transfer tool 60 and the holding table 70 is to be moved. The head unit 20 is moved three-dimensionally with respect to the holding table 70 by the vertical direction conveyor 30, the Y-axis direction conveyor 40Y and the X-axis direction conveyor 40X. The vertical direction conveyor 30, the Y-axis direction conveyor 40Y and the X-axis direction conveyor 40X are all located above the bottom wall 14.

As shown in FIG. 1, the vertical direction conveyor 30 includes a Z-axis direction feed screw stock 31, a Z-axis direction moving motor 32, and a feed nut 33. The Z-axis direction feed screw stock 31 extends in a Z-axis direction. The Z-axis direction feed screw stock 31 includes a spiral thread groove. A top portion of the Z-axis direction feed screw stock 31 is secured to the top wall 17. A top end of the Z-axis direction feed screw stock 31 runs through a bottom surface of the top wall 17 in the Z-axis direction, and a portion thereof is located inside the top wall 17. A bottom end of the Z-axis direction feed screw stock 31 is rotatably supported by a frame 14b (see also FIG. 3). The frame 14b is secured to the bottom wall 14. The Z-axis direction moving motor 32 is connected with the controller 100 (see FIG. 2). The Z-axis direction moving motor 32 is secured to the top wall 17. A driving shaft of the Z-axis direction moving motor 32 runs through the bottom surface of the top wall 17 in the Z-axis direction, and a portion thereof is located inside the top wall 17. Inside the top wall 17, the Z-axis direction feed screw stock 31 is coupled with the Z-axis direction moving motor 32. The Z-axis direction moving motor 32 rotates the Z-axis direction feed screw stock 31.

As shown in FIG. 2, the Z-axis direction feed screw stock 31 is engaged with the feed nut 33 including a screw thread. A pair of slide shafts 34 each extending in the Z-axis direction are provided inner to the left side wall 15 and the right side wall 16, respectively. The slide shafts 34 are located parallel or substantially parallel to the Z-axis direction feed screw stock 31. An elevatable base 35 is engaged with the slide shafts 34 to be slidable in the Z-axis direction. The elevatable base 35 is provided with the feed nut 33. The elevatable base 35 is supported by the Z-axis direction feed screw stock 31 via the feed nut 33. When the Z-axis direction moving motor 32 is driven, the elevatable base 35 moves, by the rotation of the Z-axis direction feed screw stock 31, in the up-down direction along the slide shafts 34. The elevatable base 35 is provided with the Y-axis direction conveyor 40Y and the X-axis direction conveyor 40X. Therefore, the Y-axis direction conveyor 40Y and the X-axis direction conveyor 40X integrally move in the up-down direction along with the movement of the elevatable base 35 in the up-down direction.

As shown in FIG. 2, the Y-axis direction conveyor 40Y moves the head unit 20 in the Y-axis direction (in the front-rear direction). The Y-axis direction conveyor 40Y includes a Y-axis direction feed screw stock 41, a Y-axis direction moving motor 42, and a feed nut 43. The Y-axis direction feed screw stock 41 extends in the Y-axis direction. The elevatable base 35 is provided with the Y-axis direction feed screw stock 41. The Y-axis direction feed screw stock 41 includes a spiral thread groove. A rear end of the Y-axis direction feed screw stock 41 is coupled with the Y-axis direction moving motor 42. The Y-axis direction moving motor 42 is connected with the controller 100. The Y-axis direction moving motor 42 is secured to a rear surface of the elevatable base 35. The Y-axis direction moving motor 42 rotates the Y-axis direction feed screw stock 41. The thread groove of the Y-axis direction feed screw stock 41 is engaged with the feed nut 43, which includes a screw thread. The elevatable base 35 is provided with a pair of slide shafts 44 extending in the Y-axis direction. The two slide shafts 44 are located parallel or substantially parallel to the Y-axis direction feed screw stock 41. A slide base 45 is engaged with the slide shafts 44 to be slidable in the Y-axis direction. The slide base 45 is provided with the slide nut 43. When the Y-axis direction moving motor 42 is driven, the slide base 45 moves, by the rotation of the Y-axis direction feed screw stock 41, in the front-rear direction along the slide shafts 44.

As shown in FIG. 1, the X-axis direction conveyor 40X moves the head unit 20 in the X-axis direction (in the left-right direction). The X-axis direction conveyor 40X includes an X-axis direction feed screw stock 46 and an X-axis direction moving motor 47. The X-axis direction feed screw stock 46 extends in the X-axis direction. The X-axis direction feed screw stock 46 is provided to the front of the slide base 45. The X-axis direction feed screw stock 46 includes a spiral thread groove. An end of the X-axis direction feed screw stock 46 is coupled with the X-axis direction moving motor 47. The X-axis direction moving motor 47 is connected with the controller 100 (see FIG. 2). The X-axis direction moving motor 47 is secured to a right surface of the slide base 45 extending forward. The X-axis direction moving motor 47 rotates the X-axis direction feed screw stock 46. The thread groove of the X-axis direction feed screw stock 46 is engaged with a feed nut (not shown) provided in the head unit 20. A pair of slide shafts 48 extending in the X-axis direction are provided to the front of the slide base 45. The slide shafts 48 are located parallel or substantially parallel to the X-axis direction feed screw stock 46. The head unit 20 is engaged with the slide shafts to be slidable in the X-axis direction. When the X-axis direction moving motor 47 is driven, the head unit 20 moves, by the rotation of the X-axis direction feed screw stock 46, in the left-right direction along the slide shafts 48.

FIG. 6 is a vertical cross-sectional view schematically showing a structure of the head unit 20 and the vicinity thereof. As shown in FIG. 6, the head unit 20 has the foil transfer tool 60 mounted thereon.

The foil transfer tool 60 presses the heat transfer foil 82 placed on the transfer target 80 and also radiates light toward the heat transfer foil 82. The foil transfer tool 60 is located above the holding table 70. The expression “above the holding table 70” is applied to a state where the holding table 70 is located horizontally. The light radiating from the foil transfer tool 60 is transmitted through the foil securing film 75 and is directed toward the light absorbing film 76. The foil transfer tool 60 includes a pen main body 61, the light source 62, and an optical fiber 63.

The light source 62 radiates light. In this preferred embodiment, the light source 62 radiates laser light. The light source 62 is located in the inner space of the housing 12. The laser light radiating from the light source 62 is supplied to the light absorbing film 76. The light is converted into thermal energy by the light absorbing film 76, and thus heats the heat transfer foil 82. In this preferred embodiment, the light source 62 includes a laser diode (LD) and an optical system, for example. The light source 62 is connected with the controller 100. The controller 100, for example, turns on the light source 62 to cause the light source 62 to emit the laser light, or turns off the light source 62 to cause the light source 62 to stop the emission of the laser light, and adjusts the level of energy of the laser light. The light source 62 is capable of adjusting the level of energy to be supplied to the heat transfer foil 82. The response speed of the laser light is high. Therefore, the switching of the light source 62 to emit or stop the emission of the laser light, and the change in the level of energy of the laser light, are performed instantaneously. This allows laser light having desired properties to be directed toward the light absorbing film 76.

The pen main body 61 has a lengthy cylindrical shape. The pen main body 61 is located such that a longitudinal direction thereof matches the up-down direction Z. An axis of the pen main body 61 extends in the up-down direction. The pen main body 61 includes a holder 61a, a presser 61b and a ferrule 61c.

The holder 61a is attached to a bottom portion of the pen main body 61. The holder 61a holds the presser 61b at a bottom end of the pen main body 61. The presser 61b is detachable from the holder 61a. The presser 61b presses the heat transfer foil 82 indirectly, namely, via the foil securing film 75 and the light absorbing film 76. The presser 61b is made of a hard material. There is no precise limitation on the hardness of the presser 61b, but the presser 61b is made of a material having a Vickers hardness of, for example, 100 Hv_{0.2} or greater (e.g., 500 Hv_{0.2} or greater). The presser 61b is spherical. The presser 61b is made of a material that transmits the light emitted from the light source 62. The presser 61b is made of, for example, synthetic quartz glass.

The ferule 61c is accommodated inside the pen main body 61. The ferule 61c is cylindrical. The ferule 61c is located such that a cylindrical axis thereof matches the up-down direction. The ferule 61c has a through-hole 61c1 formed along the cylindrical axis. A bottom end of the through-hole 61c1 extends to a bottom end portion of the holder 61a that holds the presser 61b.

The optical fiber 63 is a fiber light transmission medium that transmits light radiating from the light source 62. The optical fiber 63 includes a core portion (not shown) through which light is transmitted, and a clad portion (not shown) covering the core portion and reflecting light. One end 63a of the optical fiber 63 is connected with the light source 62. The other end 63b of the optical fiber 63 is inserted into the through-hole 61c1 of the ferule 61c. The laser light radiating from the light source 62 reaches the presser 61b via the optical fiber 63, is transmitted through the presser 61b, and is directed toward the light absorbing film 76.

As shown in FIG. 6, the head unit 20 includes a head 21, an engager 22, and a press sensor 23. The head 21 holds the foil transfer tool 60. The head 21 is engaged with the engager 22 via a slider 23a (described below) of the press sensor 23.

The engager 22 is engaged with the X-axis direction conveyor 40X. The X-axis direction conveyor 40X moves the head unit 20 in the X-axis direction via the engager 22. The engager includes a feed nut (not shown) engaged with the X-axis direction feed screw stock 46 of the X-axis direction conveyor 40X and also includes a bush (not shown) engaged with the slide shafts 48. The press sensor 23 is attached to a front surface of the engager 22. The press sensor 23 includes the slider 23a holding the head 21 such that the head 21 is movable in the up-down direction, and also includes a sensor 23b and an arm 23c sensed by the sensor 23b when the head 21 is moved upward.

The slider 23a includes two slide shafts 23a1 and a spring 23a2. The slide shafts 23a1 extend in the up-down direction. The slide shafts 23a1 are engaged with the head 21. The head 21 is movable in the up-down direction along the slide shafts 23a1. The spring 23a2 of the slider 23a is located above the head 21. The spring 23a2 includes a spring. The spring of the spring 23a2 is located in a compressed state. The spring 23a2 presses the head 21 downward by a restoring force of the spring. The head 21 does not move upward with respect to the engager 22 unless being pressed upward at a pressing force larger than, or equal to, the pressing force of the spring 23a2.

The sensor 23b of the press sensor 23 is located above the head 21. The sensor 23b senses that the foil transfer tool 60 has moved upward with respect to the slider 23a. The sensor 23b also transmits a signal at this point. The sensor 23b is connected with the controller 100. The controller 100 receives the signal transmitted by the sensor 23b. The sensor 23b is, for example, a mechanical sensor including a switch. The sensor 23b does not need to be a mechanical sensor, and may be, for example, a photoelectric sensor or the like. The sensor 23b includes a switch 23b1 protruding externally.

The arm 23c is provided on the head 21. In this preferred embodiment, the arm 23c is provided on a right side surface of the head 21. The arm 23c extends upward. A top end of the arm 23c is located in the vicinity of the sensor 23b of the press sensor 23. When the head unit 20 is moved downward by the vertical direction conveyor 30, if there is an object such as, for example, the transfer target 80 or the like below the head 21, the head 21 collides against the object. When the head unit 20 is moved downward by a force larger than, or equal to, an elastic force of the spring 23a2 from the state where the head 21 collides against the object, the head 21 moves upward along the slide shafts 23a1. When the head 21 moves upward by a certain distance (distance L1 in FIG. 6) with respect to the engager 22, the arm 23c presses the switch 23b1 of the sensor 23b. In this preferred embodiment, the sensor 23b transmits a signal when the switch 23b1 is pressed. The controller 100 understands that the foil transfer tool 60 is pressed upward based on the signal from the sensor 23b. Hereinafter, a pressure at which the foil transfer tool 60 presses the heat transfer foil 82 at the time when the sensor 23b transmits a signal will be referred to as a “first pressure”. In other words, the press sensor 23 transmits a signal when the foil transfer tool 60 is pressed upward at a pressure larger than, or equal to, the first pressure.

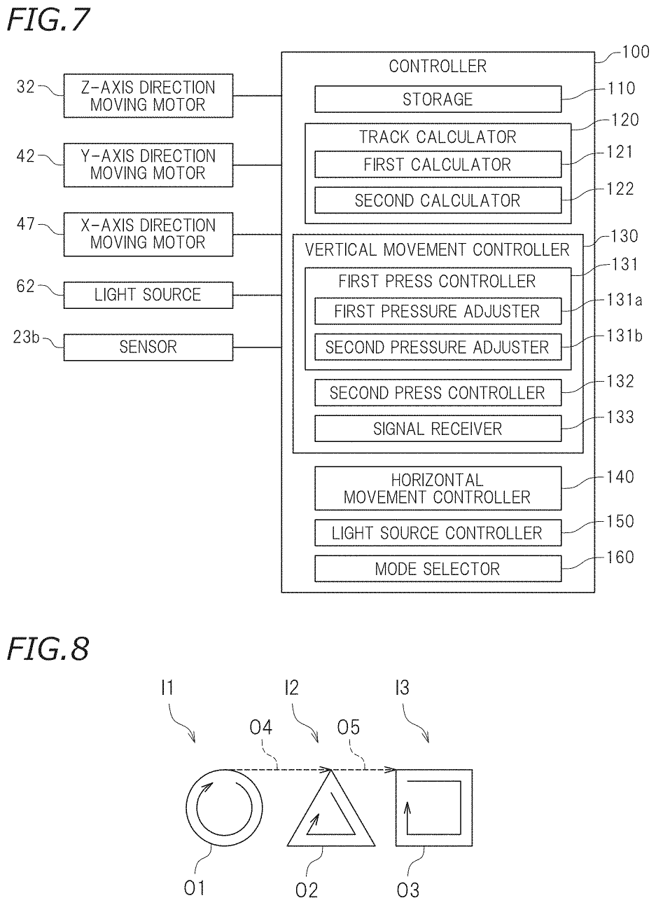

An operation of the foil transfer device 10 is controlled by the controller 100. FIG. 7 is a block diagram of the foil transfer device 10 in this preferred embodiment. As shown in FIG. 7, the controller 100 is electrically connected with, and is capable of controlling, the Z-axis direction moving motor 32, the Y-axis direction moving motor 42, the X-axis direction moving motor 47 and the light source 62. The controller 100 is connected with the sensor 23b, and receives a signal from the sensor 23b. The controller 100 is typically a computer. The controller 100 includes, for example, an interface (I/F) receiving foil-transferred data or the like from an external device such as a host computer or the like, a central processing unit (CPU) executing a command from a control program, a ROM storing the program to be executed by the CPU, a RAM usable as a working area where the program is developed, and a storage device, such as a memory or the like, storing the above-described program and various types of data.

As shown in FIG. 7, the controller 100 is configured or programmed to include a storage 110, a track calculator 120, a vertical movement controller 130, a horizontal movement controller 140, a light source controller 150, and a mode selector 160.

The storage 110 stores data on an image to be transferred to the transfer target 80. The data on the image is, for example, created by an external computer or the like connected with the foil transfer device 10 and stored on the storage 110.

The track calculator 120 calculates, based on the data stored on the storage 110, a track on which the foil transfer tool 60 is moved in the horizontal direction by the horizontal direction conveyor 40. The track calculator 120 also divides the calculated track into a transfer track on which the foil transfer tool 60 is moved by the horizontal direction conveyor 40 while performing the foil transfer and a non-transfer track on which the foil transfer tool 60 is moved by the horizontal direction conveyor 40 while not performing the foil transfer. The track calculator 120 includes a first calculator 121 and a second calculator 122.

The first calculator 121 calculates, based on the data stored on the storage 110, the track on which the foil transfer tool 60 is moved in the horizontal direction by the horizontal direction conveyor 40. FIG. 8 is a schematic view showing an example of image to be foil-transferred. As shown in FIG. 8, an image to be foil-transferred may be a combination of a plurality of image portions separate from each other. In the case of the image shown in FIG. 8, the image includes a first image portion I1, a second image portion I2 and a third image portion I3 separate from each other. In this case, the foil transfer tool 60 is moved horizontally on tracks O1, O2 and O3 (hereinafter, referred to as the “transfer tracks”) while foil-transferring the first image portion I1, the second image portion I2 and the third image portion I3 respectively and also is moved on, for example, a track O4 while moving from the first image portion I1 to the second image portion I2 and on a track O5 while moving from the second image portion I2 to the third image portion I3 (hereinafter, the tracks O4 and O5 may be referred to as the “non-transfer tracks” when appropriate). The transfer tracks O1 through O3 are tracks on which the foil transfer tool 60 moves while foil-transferring the image. The non-transfer tracks O4 and O5 are tracks on which the foil transfer tool 60 moves while not foil-transferring the image. The first calculator 121 calculates, based on the image data to be foil-transferred, a track as the sum of the transfer tracks and the non-transfer tracks (in the case of FIG. 8, the track as the sum of all the tracks O1 through O5). The second calculator 122 divides the track calculated by the first calculator 121 into the transfer tracks and the non-transfer tracks.

The vertical movement controller 130 controls the vertical direction conveyor 30 to move the foil transfer tool 60 in the vertical direction. The vertical movement controller 130 includes a first press controller 131, a second press controller 132 and a signal receiver 133. When the mode selector 160 described below selects a first mode as a foil transfer mode, the first press controller 131 controls the movement of the vertical direction conveyor 30. In the case where the first mode is selected, while the foil transfer tool 60 is moved on any of the transfer tracks, the first press controller 131 keeps the foil transfer tool 60 in a state of being in contact with the heat transfer foil 82 and pressing the heat transfer foil 82 at a pressure larger than, or equal to, the first pressure. Hereinafter, the state where the foil transfer tool 60 is in contact with the heat transfer foil 82 and presses the heat transfer foil 82 at a pressure larger than, or equal to, the first pressure will be referred to as a “first state”.

In this preferred embodiment, the foil transfer tool 60 is in indirect contact with the heat transfer foil 82 via the foil securing film 75 and the light absorbing film 76, and presses the heat transfer foil 82. Hereinafter, the state where the foil transfer tool 60 is in indirect contact with the heat transfer foil 82 via the foil securing film 75 and the light absorbing film 76 and presses the heat transfer foil 82 will be described simply as that “the foil transfer tool 60 is in contact with the heat transfer foil 82 and presses the heat transfer foil 82”. The heat transfer foil 82 may be secured by any other method than use of the foil securing film 75 or may include a light absorbing layer. Therefore, the foil transfer tool 60 may be in direct contact with the heat transfer foil 82 to press the heat transfer foil 82.

While the foil transfer tool 60 is moved on any of the non-transfer tracks, the first press controller 131 keeps the foil transfer tool 60 in a state of being in contact with the heat transfer foil 82 and pressing the heat transfer foil 82 at a pressure smaller than the first pressure. Hereinafter, the state where the foil transfer tool 60 is in contact with the heat transfer foil 82 and presses the heat transfer foil 82 at a pressure smaller than the first pressure will be referred to as a “second state”. The second state will be described below in detail.

The first press controller 131 includes a first pressure adjuster 131a and a second pressure adjuster 131b. The first pressure adjuster 131a controls an operation of transferring the foil transfer tool 60 from the second state to the first state. The second pressure adjuster 131b controls an operation of transferring the foil transfer tool 60 from the first state to the second state. Such controls will be described below in detail.

When the mode selector 160 selects a second mode as the foil transfer mode, the second press controller 132 controls the movement of the vertical direction conveyor 30. In the case where the second mode is selected by the mode selector 160, the second press controller 132 keeps the foil transfer tool 60 in the first state. The first mode and the second mode will be described below in detail.

The signal receiver 133 is connected with the press sensor 23 and receives a signal transmitted by the press sensor 23. The signal receiver 133 receives the signal from the sensor 23b, and as a result, the controller 100 understands that the foil transfer tool 60 is pressing the heat transfer foil 82 at a pressure larger than, or equal to, the first pressure. The signal receiver 133 stops receiving the signal from the sensor 23b, and as a result, the controller 100 understands that the pressure at which the foil transfer tool 60 presses the heat transfer foil 82 has become smaller than the first pressure.

The horizontal movement controller 140 controls the horizontal direction conveyor 40 to move the foil transfer tool 60 in the horizontal direction along the track calculated by the first calculator 121. In other words, the horizontal movement controller 140 moves the foil transfer tool 60 in the horizontal direction along the transfer tracks and the non-transfer tracks.

The light source controller 150 controls the energy of the light that is output by the foil transfer tool 60. In more detail, while the foil transfer tool 60 is moved on any of the transfer tracks, the light source controller 150 causes the foil transfer tool 60 to output a level of energy that realizes the foil transfer. While the foil transfer tool 60 is moved on any of the non-transfer tracks, the light source controller 150 causes the foil transfer tool 60 not to output the level of energy that realizes the foil transfer. In this preferred embodiment, while the foil transfer is performed, the light source controller 150 controls the level of electric current to be supplied to the light source 62 in order to allow the foil transfer tool 60 to output light of a level of energy that realizes the foil transfer. While the foil transfer is not performed, the light source controller 150 turns off the light source 62 in order to prevent the foil transfer tool 60 from outputting light of the level of energy that realizes the foil transfer. The method by which the light source controller 150 controls the operation of the foil transfer tool 60 and the level of the energy is not limited to the above method. For example, the light source controller 150 may control the output of the foil transfer tool 60 by supplying a pulse current to flicker the light source 62. For example, the light source 62 may be turned on at a low level of electric current instead of being turned off.

The mode selector 160 is capable of selecting the first mode or the second mode as the transfer mode. In this preferred embodiment, the first mode and the second mode are available as the foil transfer mode. Alternatively, there may be three or more modes available as the foil transfer mode. The mode selector 160 merely needs to be capable of selecting the transfer mode from at least the first mode and the second mode. In the case where the first mode is selected, the vertical direction conveyor 30 is controlled by the first press controller 131. In the case where the second mode is selected, the vertical direction conveyor 30 is controlled by the second press controller 132. The mode selector 160 causes, for example, a display device or the like of an external computer to display a mode selection screen.

Hereinafter, an operation of the foil transfer device 10 will be described. As an example, an operation of the foil transfer device 10 in the case where the image shown in FIG. 8 is to be foil-transferred will be described. Before the foil transfer is performed, the transfer target 80 and the heat transfer foil 82 are set on the holding table 70 by the user. In this preferred embodiment, the transfer target 80 is secured to the securing tool 70A. The heat transfer foil 82 is, for example, bonded to the foil securing film 75 and the light absorbing film 76 attached to the holder 72 of the film holding tool 70B. The holder 72 is located at the securing position P2, and as a result, the heat transfer foil 82 is secured to the transfer target 70. The foil transfer mode is selected by the user. First, a case where the first mode is selected as the foil transfer mode will be described.

### First Mode

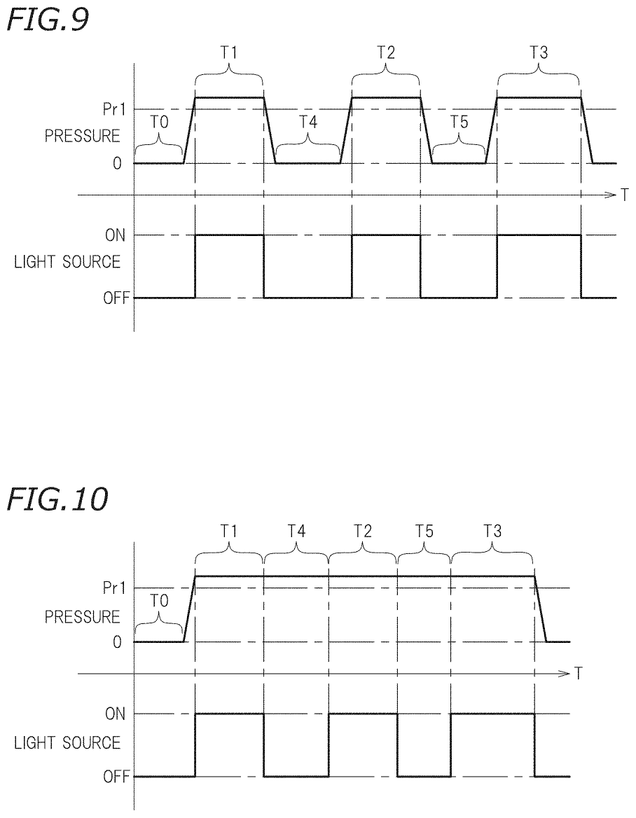

FIG. 9 is a timing diagram showing the pressure applied to the foil transfer tool 60 and the state of the light source 62 while the image shown in FIG. 8 is foil-transferred in the case where the first mode is selected. In FIG. 9, the horizontal axis represents time T. The time T represented by the horizontal axis in FIG. 9 includes time T0 used to move the foil transfer tool 60 before the first image portion I1 is foil-transferred, time T1 used to foil-transfer the first image portion I1, time T2 used to foil-transfer the second image portion I2, time t3 used to foil-transfer the third image portion I3, time T4 used to move the foil transfer tool 60 from the first image portion I1 to the second image portion I2, and time T5 used to move the foil transfer tool 60 from the second image portion I2 to the third image portion I3. The times T0 through T5 are in the order of T0, T1, T4, T2, T5 and T3.

A top portion of FIG. 9 shows the pressure applied to the foil transfer tool 60 while the image is foil-transferred. In FIG. 9, the first pressure is represented by “Pr1”, and a pressure of zero is represented by “0”. A bottom portion of FIG. 9 shows how the light source 62 is turned on and off. In FIG. 9, “ON” represents the state where the light source 62 is on, and “OFF” represents the state where the light source 62 is off.

During time T0, the foil transfer tool 60 moves above the heat transfer foil 82. At this point, the foil transfer tool 60 is out of contact with the heat transfer foil 82. Therefore, during time T0, the foil transfer tool 60 is not supplied with any upward pressing force. The controller 100 recognizes that no pressing force larger than, or equal to, the first pressure Pr1 is applied to the foil transfer tool 60 because the signal receiver 133 does not receive any signal from the sensor 23b.

During time T0, the light source 62 is off. During time T0, the foil transfer is not performed, and thus there is need to turn on the light source 62.

While moving from a track before the first track O1 (corresponding to time T0) to the first track O1 (corresponding to time T1), the foil transfer tool 60 is transferred to the first state. In order to transfer the foil transfer tool 60 to the first state, the first pressure adjuster 131a of the first press controller 131 moves down the foil transfer tool 60 at least until the signal receiver 133 receives a signal from the press sensor 23. In this preferred embodiment, the first pressure adjuster 131a moves down the foil transfer tool 60 until slightly after the signal receiver 133 receives a signal from the press sensor 23.

While being transferred to the first state, the foil transfer tool 60 is moved down by the vertical direction conveyor 30. Then, the presser 61b provided at the bottom end of the foil transfer tool 60 contacts the heat transfer foil 82. When the vertical direction conveyor 30 further moves down the foil transfer tool 60, the foil transfer tool 60 presses the heat transfer foil 82. When the pressing force exceeds a predetermined value, the head 21 moves upward along the slider 23a. When the moving distance of the head 21 becomes longer than, or equal to, a certain distance (L1 in FIG. 6), the arm 23c turns on the sensor 23b. At this point, the foil transfer tool 60 is supplied with the first pressure Pr1. In this preferred embodiment, the downward movement of the foil transfer tool 60 is stopped slightly after the sensor 23b is turned on. In this case, the pressure at which the foil transfer tool 60 presses the heat transfer foil 82 is larger than the first pressure Pr1.

Alternatively, the downward movement of the foil transfer tool 60 may be stopped when the sensor 23b is turned on. In this case, the pressure at which the foil transfer tool 60 presses the heat transfer foil 82 is equal to the first pressure Pr1.

During time T1, the first press controller 131 controls the vertical direction conveyor 30 to keep the foil transfer tool pressing the heat transfer foil 82, whereas the horizontal movement controller 140 controls the horizontal direction conveyor 40 such that the foil transfer tool 60 follows the first track O1. As shown in FIG. 9, the light source 62 is kept on during time T1.

The first image portion I1 is foil-transferred as follows. A region of the light absorbing film 76 that is irradiated with the laser light from the light source 62 absorbs the laser light. As a result, the optical energy is converted into thermal energy. The light absorbing film 76 generates heat upon receipt of the laser light, and the heat is transmitted to the adhesive layer of the heat transfer foil 82. This causes the adhesive layer to be softened and express the adhesiveness. The adhesive layer is adhered to surfaces of the decoration layer and the transfer target 80, and thus puts the decoration layer and the transfer target 80 into close contact with each other. Then, the foil transfer tool 60 moves and thus the supply of the optical energy to the above-mentioned irradiated region is finished. After this occurs, the adhesive layer is cooled by heat dissipation and thus is cured. As a result, the surfaces of the decoration layer and the transfer target 80 are fixed to each other. Thus, the foil transfer in the above-mentioned region is finished. The above-described operation is performed in different regions in the horizontal direction, and thus the foil transfer to the transfer target 80 is finished.

The above-described mechanism of foil transfer is realized by the foil transfer tool 60 directly or indirectly pressing the heat transfer foil 82 while the laser light is radiating and the heat transfer foil 82 being pressed onto the transfer target 80.

While moving from the first track O1 (corresponding to time T1) to the fourth track O4 (corresponding to time T4), the foil transfer tool 60 is transferred from the first state to the second state. In order to transfer the foil transfer tool 60 from the first state to the second state, the second pressure adjuster 131b of the first press controller 131 moves up the foil transfer tool 60 at least until the signal receiver 133 stops receiving a signal from the press sensor 23. In this preferred embodiment, the second pressure adjuster 131b moves up the foil transfer tool 60 until slightly after the signal receiver 133 stops receiving a signal from the press sensor 23.

While the foil transfer tool 60 is transferred from the first state to the second state, the elevatable base 35 is moved up by the vertical direction conveyor 30. This movement weakens the force at which the bottom end of the foil transfer tool 60 presses the heat transfer foil 82. When the pressing force becomes smaller than the first pressure Pr1, the arm 23c is separated from the switch 23b1 of the sensor 23b. This turn off the switch 23b1. In this preferred embodiment, the upward movement of the elevatable base 35 is stopped slightly after the sensor 23b is turned off. In more detail, the elevatable base 35 is stopped after moving up by distance L1 (see FIG. 5) after the sensor 23b is turned off. At this point, the elevatable base 35 is stopped at a position that is calculated as the position at which the foil transfer tool 60 is about to go out of contact with the heat transfer foil 82. At this point, the pressing force of the foil transfer tool 60 becomes zero. The second state is a state where the pressure at which the foil transfer tool 60 presses the heat transfer foil 82 is zero. Herein, the expression that “the pressing force is zero” encompasses a case where the pressing force of the foil transfer tool 60 is sufficiently smaller than in the first state and is substantially zero.

Alternatively, the upward movement of the elevatable base 35 may be stopped when the sensor 23b is turned off. In this case, the pressure at which the foil transfer tool 60 presses the heat transfer foil 82 in the second state is slightly smaller than, or equal to, the first pressure Pr1. Still alternatively, the elevatable base 35 may be stopped at a position between the position thereof when the sensor 23b is turned off and the position thereof when a tip of the foil transfer tool 60 goes out of contact with the heat transfer foil 82. In this case, the pressure at which the foil transfer tool 60 presses the heat transfer foil 82 in the second state is smaller than the first pressure Pr1 and larger than zero.

During time T4, the foil transfer tool 60 is moved on the fourth track O4 between the first image portion I1 and the second image portion I2. The fourth track O4 is one of the non-transfer tracks. During time T4, the first press controller 131 controls the vertical direction conveyor 30 to keep the foil transfer tool 60 in the second state, whereas the horizontal movement controller 140 controls the horizontal direction conveyor 40 such that the foil transfer tool 60 follows the fourth track O4. As shown in FIG. 9, the light source 62 is kept off during time T4.

During time T4, the laser light is not radiating toward the heat transfer foil 82, and the foil transfer tool 60 does not press the heat transfer foil 82 at a pressure larger than, or equal to, the first pressure Pr1. Therefore, the foil transfer is not performed.

After this, in substantially the same manner, the foil transfer tool 60 is transferred between the first state and the second state while moving on the tracks. While moving from the fourth track O4 (corresponding to time T4) to the second track O2 (corresponding to time T2), the foil transfer tool 60 is transferred from the second state to the first state. During time T2, the foil transfer tool 60 is moved on the second track O2 while being kept in the first state. While moving from the second track O2 (corresponding to time T2) to the fifth track O5 (corresponding to time T5), the foil transfer tool 60 is transferred from the first state to the second state. During time T5, the foil transfer tool 60 is moved on the fifth track O5 while being kept in the second state. While moving from the fifth track O5 (corresponding to time T5) to the third track O3 (corresponding to time T3), the foil transfer tool 60 is transferred from the second state to the first state. During time T3, the foil transfer tool 60 is moved on the third track O3 while being kept in the first state.

In other words, in the first mode, while moving on the transfer tracks, the foil transfer tool 60 is kept in a state of pressing the heat transfer foil 82 while being in contact with the heat transfer foil 82. Thus, the foil transfer is performed. In the first mode, while moving on the non-transfer tracks, the foil transfer tool 60 is kept in a state of not pressing the heat transfer foil 82 while being in contact with the heat transfer foil 82. Thus, the foil transfer tool 60 passes above the heat transfer foil 82 without performing the foil transfer.

As described above, according to the foil transfer in the first mode, while the foil transfer tool 60 is moved on the non-transfer tracks, the heat transfer foil 82 is not pressed and thus the foil transfer is not performed.

The foil transfer in the first mode may improve the productivity as compared with a method by which the foil transfer tool 60 is completely out of contact with the heat transfer foil 82 while moving on the non-transfer tracks. According to the method by which the foil transfer tool 60 is completely out of contact with the heat transfer foil 82 while moving on the non-transfer tracks, the operation of moving up the foil transfer tool 60 to move the foil transfer tool 60 from the transfer track to the non-transfer track, and the operation of moving down the foil transfer tool 60 to move the foil transfer tool 60 from the non-transfer track to the transfer track, each require a certain period of time. According to the foil transfer in the first mode in this preferred embodiment, the foil transfer tool 60 is in contact with the heat transfer foil 82 even while moving on the non-transfer tracks. Therefore, the distance by which the foil transfer tool 60 is moved up to be moved from the transfer track to the non-transfer track, and the distance by which the foil transfer tool 60 is moved down to be moved from the non-transfer track to the transfer track, are short. This shortens the time required to move the foil transfer tool 60 from the transfer track to the non-transfer track, and the time required to move the foil transfer tool 60 from the non-transfer track to the transfer track. As a result, the productivity of the foil transfer is improved.

In the first mode, the foil transfer tool 60 does not press the heat transfer foil 82 while moving on the non-transfer track. Therefore, the risk that the non-transfer track is left as a trace in the transfer target 80 is low. For example, in the case where the transfer target 80 is made of a soft material, if the force at which the heat transfer foil 82 is pressed is strong, the trace of the movement of the foil transfer tool 60 on the non-transfer track may be left in the transfer target 80. According to the foil transfer in the first mode in this preferred embodiment, the foil transfer tool 60 weakens the pressing pressure on the transfer target 80 while moving on the non-transfer track. Therefore, such a possibility is decreased.

Especially in this preferred embodiment, the pressure at which the foil transfer tool 60 presses the heat transfer foil 82 is made substantially zero. In this manner, the possibility that the trace of the foil transfer tool 60 pressing the heat transfer foil 82 is left in the transfer target 80 is substantially eliminated.

In this preferred embodiment, the foil transfer device 10 includes the press sensor 23, which senses whether or not the foil transfer tool 60 is pressing the heat transfer foil 82 at a pressure larger than, or equal to, the predetermined pressure. Based on the sensing result of the press sensor 23, the operation of the vertical direction conveyor 30 is controlled. The press sensor 23 operating in such a manner and such a control allow the foil transfer tool 60 to be transferred to the first state or the second state without fail.

A preferred source of energy that supplies the heat transfer foil 82 with heat may be a laser light source. A laser light source, when being turned off, loses the effect of heating the heat transfer foil 82 in a very short period of time. Therefore, even if the foil transfer tool 60 is in contact with the heat transfer foil 82 in the second state, the risk that the adhesive layer is melted is low.

### Second Mode

Now, the second mode will be described. FIG. 10 is a timing diagram showing the pressure applied to the foil transfer tool 60 and the state of the light source 62 while the image shown in FIG. 8 is foil-transferred in the case where the second mode is selected. In FIG. 10, the horizontal axis, the vertical axis and the times T1 through T5 are the same as in FIG. 9.

As shown in FIG. 10, in the second mode, the foil transfer tool 60 keeps pressing the heat transfer foil 82 at a pressure larger than, or equal to, the first pressure Pr1 from the start of the foil transfer (in FIG. 10, start of time T1) to the end of the foil transfer (in FIG. 10, the end of time T3). In the case where the second mode is selected by the mode selector 160, the second press controller 132 in this preferred embodiment keeps the foil transfer tool 60 in the first state.

In the second mode also, the light source controller 150 in this preferred embodiment keeps the light source 62 on while the foil transfer tool 60 is moved on the transfer tracks and keeps the light source 62 off while the foil transfer tool 60 is moved on the non-transfer tracks. The light source controller 150 keeps the light source 62 on only while the foil transfer is performed, and keeps the light source 62 off while the foil transfer is not performed.

As described above, the foil transfer is performed by the foil transfer tool 60 pressing the heat transfer foil 82 while the laser light is radiating and the heat transfer foil 82 being pressed onto the transfer target 80. While the radiation of the laser light is stopped, the foil transfer is not performed. Therefore, in the second mode also, the foil transfer is performed only while the foil transfer tool 60 is moved on the transfer tracks, and the foil transfer is not performed while the foil transfer tool 60 is moved on the non-transfer tracks.

According to the foil transfer in the second mode, in the case where, for example, the transfer target 80 is made of a soft material, the trace of the foil transfer tool 60 pressing the heat transfer foil 82 may be left in the transfer target 80. However, according to the second mode, it is not needed to switch the pressing state of the foil transfer tool 60 while the foil transfer tool 60 is moved between the transfer track and the non-transfer track, and the time required for the foil transfer is shortened. As can be seen from FIG. 9 and FIG. 10, the total time from the start of time T1 to the end of time T3 is shorter in FIG. 10 than in FIG. 9. In the case where the productivity is prioritized than not leaving the trace in the transfer target 80, the second mode is preferably usable. The second mode is also preferably usable in the case where, for example, the transfer target 80 is made of a material that is hard and does not allow the trace to be left easily.

As described above, the foil transfer device 10 in this preferred embodiment uses the first mode and the second mode in different cases or for different purposes and provides a good balance between the foil transfer quality and the productivity.

Some preferred embodiments of the present invention have been described. The above-described preferred embodiments are merely examples, and the present invention may be carried out in any of various forms. For example, in the above-described preferred embodiments, the foil transfer tool 60 is switched to the first state or the second state based on the sensing result of the press sensor 23. Alternatively, the state of the foil transfer tool 60 may be switched based on, for example, a pulse that is output by an encoder included in the vertical direction conveyor 30. Namely, the state of the foil transfer tool 60 may be switched based on the position of the foil transfer tool 60 in the vertical direction. The press sensor 23 is not limited to having the above-described structure. For example, the press sensor 23 may include a pressure sensor that directly measures the pressure applied to the foil transfer tool 60.

In the above-described preferred embodiments, the foil transfer device 10 is capable of selecting the first mode or the second mode as the foil transfer mode. The present invention is not limited to this. For example, the foil transfer device 10 may always perform the foil transfers in the first mode.

In the above-described preferred embodiments, the foil transfer tool 60 includes the light source 62. The heat transfer foil 82 is not limited to being supplied with energy by the laser light source. The heat transfer foil 82 may be supplied with energy by, for example, a heat pen or the like. The effect of the foil transfer in the first mode may be provided by, for example, a foil transfer device including a foil transfer tool that includes a heat pen.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A foil transfer device, comprising:
a holding table that holds a transfer target with a heat transfer foil placed thereon;
a foil transfer tool located above the holding table;
a horizontal direction conveyor that moves the foil transfer tool and the holding table in a horizontal direction with respect to each other;
a vertical direction conveyor that moves the foil transfer tool and the holding table in a vertical direction with respect to each other; and
a controller; wherein
the controller includes:
a storage that stores data on an image to be foil-transferred onto the transfer target;
a track calculator that calculates, based on the data stored on the storage, a track on which the foil transfer tool and the holding table are moved in the horizontal direction with respect to each other by the horizontal direction conveyor, and divides the track into a transfer track on which the foil transfer tool foil-transfers the image and a non-transfer track on which the foil transfer tool does not foil-transfer the image;
a horizontal movement controller that controls the horizontal direction conveyor to move the foil transfer tool and the holding table with respect to each other in the horizontal direction along the track calculated by the track calculator; and
a vertical movement controller that controls the vertical direction conveyor to move the foil transfer tool and the holding table with respect to each other in the vertical direction; and
the vertical movement controller:
while the foil transfer tool and the holding table are moved on the transfer track with respect to each other, keeps the foil transfer tool in a first state where the foil transfer tool is in direct or indirect contact with the heat transfer foil and presses the heat transfer foil at a pressure larger than, or equal to, a first pressure; and
while the foil transfer tool and the holding table are moved on the non-transfer track with respect to each other, keeps the foil transfer tool in a second state where the foil transfer tool is in direct or indirect contact with the heat transfer foil and presses the heat transfer foil at a pressure smaller than, or equal to, the first pressure.

2. The foil transfer device according to claim 1, wherein the second state is a state where the pressure at which the foil transfer tool presses the heat transfer foil is zero or substantially zero.

3. The foil transfer device according to claim 1, wherein the foil transfer tool includes a light source that radiates light.

4. A foil transfer device, comprising:
a holding table that holds a transfer target with a heat transfer foil placed thereon;
a foil transfer tool located above the holding table;
a horizontal direction conveyor that moves the foil transfer tool and the holding table in a horizontal direction with respect to each other;
a vertical direction conveyor that moves the foil transfer tool and the holding table in a vertical direction with respect to each other; and
a controller; wherein
the controller includes:
a storage that stores data on an image to be foil-transferred onto the transfer target;
a track calculator that calculates, based on the data stored on the storage, a track on which the foil transfer tool and the holding table are moved in the horizontal direction with respect to each other by the horizontal direction conveyor, and divides the track into a transfer track on which the foil transfer tool foil-transfers the image and a non-transfer track on which the foil transfer tool does not foil-transfer the image;
a horizontal movement controller that controls the horizontal direction conveyor to move the foil transfer tool and the holding table with respect to each other in the horizontal direction along the track calculated by the track calculator;
a vertical movement controller that controls the vertical direction conveyor to move the foil transfer tool and the holding table with respect to each other in the vertical direction;
a mode selector that is capable of selecting a transfer mode from at least a first mode and a second mode; and
an energy controller that controls a level of energy of the foil transfer tool;
the energy controller causes the foil transfer tool to output a level of energy that realizes the foil transfer while the foil transfer tool and the holding table are moved with respect to each other on the transfer track, and does not cause the foil transfer tool to output the level of energy that realizes the foil transfer while the foil transfer tool and the holding table are moved with respect to each other on the non-transfer track; and
the vertical movement controller:
in a case where the first mode is selected by the mode selector, while the foil transfer tool and the holding table are moved on the non-transfer track with respect to each other, controls the vertical direction conveyor such that the foil transfer tool presses the heat transfer foil at a pressure smaller than a pressure while the foil transfer tool and the holding table are moved on the transfer track with respect to each other; and
in a case where the second mode is selected by the mode selector, controls the vertical direction conveyor such that the foil transfer tool presses the heat transfer foil at an equal pressure while the foil transfer tool and the holding table are moved on the non-transfer track with respect to each other and while the foil transfer tool and the holding table are moved on the transfer track with respect to each other.

5. The foil transfer device according to claim 4, wherein while the foil transfer tool and the holding table are moved on the non-transfer track with respect to each other in the first mode, the pressure at which the foil transfer tool presses the heat transfer foil is zero or substantially zero.

6. The foil transfer device according to claim 4, wherein the foil transfer tool includes a light source that radiates light.
